(19) United States
(12) Patent Application Publication
(10) Pub. No.: US 2016/0086247 A1
(43) Pub. Date: Mar. 24, 2016

(54) FACILITATING ACCESS TO NATURAL PRODUCTS HAVING CONSUMER SPECIFIED CHARACTERISTICS

(71) Applicant: Carbon Bond Holdings, Denver, CO (US)

(72) Inventor: Steven Kilts, Denver, CO (US)

(21) Appl. No.: 14/489,668

(22) Filed: Sep. 18, 2014

(51) Int. Cl. G06Q 30/06; G06F 17/30; G06Q 30/00

(52) U.S. Cl. CPC G06Q 30/0627; G06Q 30/0639; G06Q 30/018; G06F 17/30424

(57) ABSTRACT

Product samples comprising natural products are received and tested at one or more testing facilities. The samples are evaluated to determine at least one chemical characteristic pertaining to each product sample. Data concerning the specified source of the natural product and corresponding information concerning the chemical characteristic of each the product sample is stored on a database. After the data has been stored, a computer server is used to provide a user interface through which consumers can selectively access the data contained in the computer database through a global computer network, such as the Internet. Consequently, the natural product test data can be remotely accessed by potential consumer purchasers of the natural product.

### BACKGROUND OF THE INVENTION

1. Statement of the Technical Field

The inventive arrangements relate to consumer product distribution, and more particularly to systems and methods to facilitate distribution of certain natural products having defined characteristics and/or chemical properties.

2. Description of the Related Art

Manufactured products often have qualities that are easily ascertained by consumers based on product branding, product appearance and/or standardized labeling. Such products are often widely advertised through various marketing channels and their qualities can be readily researched and understood. Since they are manufactured under controlled conditions, the characteristics of the product can be readily controlled directly by the manufacturer. Experience has shown that product branding in such circumstances can be sufficient to satisfy consumers that the particular product possesses the qualities as advertised. As such, consumers can educate themselves regarding the quality of specific product brands and can readily locate a specific quality of product at the dispensary or retail store level.

In contrast, the process of purchasing a natural product for human consumption (or application) is often more complex. Examples of such natural products can include fruits, vegetables, plants, flowers, topicals, oils, drinks and other type of vegetative product (hereinafter collectively “natural products”). Consumers may have specific tastes, preferences or needs when it comes to such products, and it may not always be obvious where a natural product having a particular characteristic or set of characteristics can be purchased at a retail level. Various agricultural-based factors can change the characteristics of vegetative type natural products such that branding methods may not be sufficient to provide consumers with confidence that they are purchasing the products that they need or want. Even a single known variety of fruit, plant or other natural product can have characteristics that vary over time as a result of different plant varieties, strains and/or different growing conditions. As such, natural products can have variable amounts of vitamins, minerals, chemical compounds (including medicinal compounds), solvents, pesticides and heavy metals. Accordingly, even when product labeling purports that a particular product has certain characteristics, a consumer may not know with any certainty whether the product actually satisfies the purported criteria. This problem for consumers is present when natural products are consumed for their taste and/or nutritional value, but becomes an even more critical consideration when the natural product is consumed or applied to the body for medicinal reasons as an herbal remedy or otherwise.

### SUMMARY OF THE INVENTION

Embodiments of the invention concern a method to facilitate distribution and consumer access to natural products (such as vegetative products), supplements and/or nutraceuticals having certain specified characteristics. The method involves receiving product samples comprising such products at one or more testing facilities, where each product sample is associated with at least one specified source. Each of the product samples is evaluated at the one or more testing facilities to determine at least one chemical characteristic pertaining to each product sample. The method further involves storing in a computer database data concerning the specified source of the product and corresponding information concerning the at least one chemical characteristic of each the product sample. After the data has been stored, a computer server is used to provide a user interface through which consumers can selectively access the data contained in the computer database. Access to the computer server and the data contained in the database is provided through a publicly accessible computer network. Consequently, the product test data can be remotely accessed by potential consumer purchasers.

The invention also concerns a system to facilitate distribution and consumer access to products with certain specified characteristics. The system includes a computer database on which is stored a plurality of data records. The data records contain test result information concerning a plurality of product samples comprising the products. The test results are obtained by testing the products at one or more testing facilities. Each product sample is associated with at least one specified source, and the test result information includes at least one chemical characteristic determined for each product sample. A computer server accesses the data contained in the computer database and is communicatively coupled to a public computer network. The computer server is responsive to a request from at least one remote client computer to provide a computer user interface which facilitates public access to the plurality of data records contained in the computer database. More particularly, the computer server is responsive to at least one query received from the remote client computer to selectively retrieve one or more of the data records from the computer database. The computer server causes information contained in one or more of the data records to be displayed at the remote computer. Notably, the information that is displayed indicates at least one source of the product which satisfies at least one parameter specified by the consumer's query.

### BRIEF DESCRIPTION OF THE DRAWINGS

Embodiments will be described with reference to the following drawing figures, in which like numerals represent like items throughout the figures, and in which:

FIG. 1 is a flowchart that is useful for understanding the inventive arrangements.

FIG. 2 is a conceptual diagram of a computer system that is useful for understanding the inventive arrangements.

FIG. 3A is a first exemplary web page that is useful for understanding the inventive arrangements.

FIG. 3B is a second exemplary web page that is useful for understanding the inventive arrangements.

FIG. 4 is a third exemplary web page that is useful for understanding the inventive arrangements.

FIG. 5 is a block diagram that is useful for understanding the arrangement of a web server which can be used for implementing the inventive arrangements.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

The invention concerns a method and system which facilitate distribution and consumer access to certain types of products having certain specified characteristics. Such products can include natural products, supplements, and/or nutraceuticals. As used herein, the term natural products should be broadly understood to mean those products which are not manufactured, refined or assembled by humans. Natural products are often vegetative products sold in their natural or substantially natural state. Vegetative products are considered natural products because they are grown or produced by agricultural activity as opposed to being manufactured by humans. Examples of vegetative products can include fruits, vegetables, plants, flowers, and any other type of vegetative product (hereinafter collectively “vegetative products”). Natural product can also include cultivated products which have been minimally processed by mechanical means such as chopping, grinding or cutting the natural material.

Natural products can also include natural oil extracted from a particular plant by pressing or other suitable mechanical extraction means. The term nutraceutical as used herein refers to a food (such as a dietary supplement) that provides health benefits in addition to its basic nutritional value.

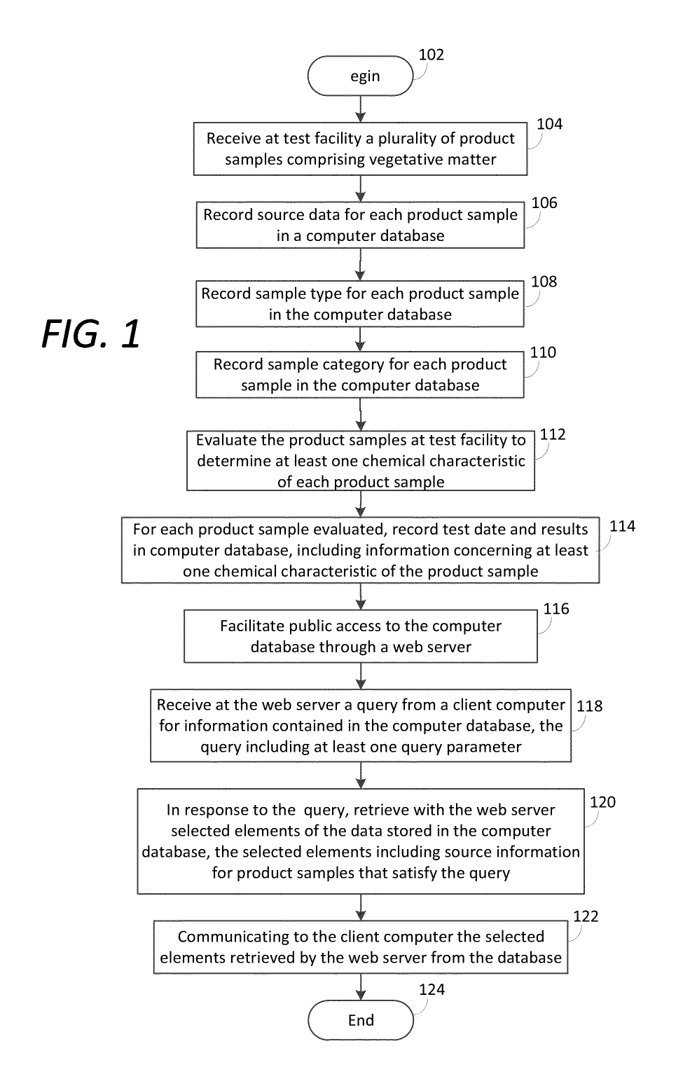

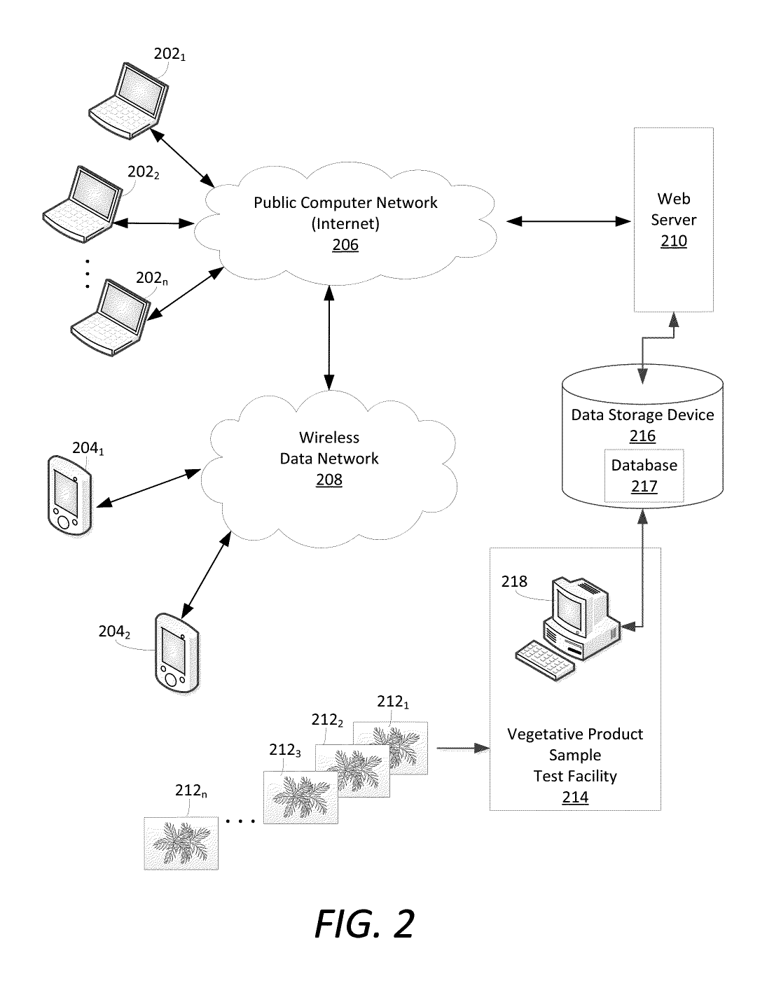

As shown in FIGS. 1 and 2, the method begins at 102 and continues at 104 with the receiving of one or more natural product samples 212₁, 212₂, . . . 212ₙ at one or more testing facilities 214. The product samples comprise natural products which are advantageously provided in a particular form as they would be offered for sale to consumers. Consequently, the product samples will generally be in a raw unprocessed form comprising a particular natural material, although some minimal processing of the samples is possible. For example, the samples can comprise a vegetative product in which certain physical structures of the plant have been isolated from other parts. Accordingly, such natural products can be exclusively comprised of one or more physical plant structures such as buds, leaves, stems, flowers, fruits and/or seeds of a particular plant. Also, in some scenarios, the natural product sample can be minimally processed by chopping, grinding, pressing or cutting the natural material.

Each product sample received at a test facility 214 is marked or otherwise designated as having a particular specified source from whence the product is made available to consumers. The specified source data is important in subsequent steps for purposes of allowing consumers to determine where a particular natural product corresponding to the natural product sample is available for purchase. Accordingly, the specified source data can advantageously include a name and address of one or more dispensaries or retail stores where the product is available for purchase. Still, the invention is not limited in this regard and in some scenarios, the specified source can also refer to a particular product name or brand which uniquely identifies the particular natural product or otherwise indicates a source of the natural products. In a further alternative embodiment, the specified source can be a particular geographic growing location where the natural product originated or was grown and can be purchased. For example, the growing location can be specified by the name of a growing facility, or can include other means for designating a particular geographic location where the natural product was grown. The specified source could also include a wholesale distribution center where the product is offered for sale. As with the retail store, the wholesale distribution center could be identified by name, by address, and/or other suitable means. The specified source information will generally include a physical address or location which indicates where the product is available for purchase.

After the natural product samples 212₁, 212₂, . . . 212ₙ are received at the test facility 214, the specified source data for each product sample is recorded in a computer database 217. The computer database is advantageously selected to be a relational database such that the various recorded data elements are stored and organized as a set of formally described tables from which data can be accessed or reassembled in various different ways as hereinafter described, without having to necessarily reorganize the database tables. Relational databases are well known and therefore will not be described here in detail. However, it will be appreciated that the data can be entered into the database manually by a human operator using a computer workstation 218 which records the specified source data in the database. Alternatively, the data can be recorded using automated processes which can include scanning devices (not shown), such as optical scanning devices, which read source data directly from labels or tags affixed to the natural product samples. The database 217 in which the specified source data is recorded is advantageously contained with a data storage device 216 that is accessible to a web server 210. The purpose of the web server 210 will become more apparent as the discussion progresses.

Additional data concerning the natural product sample is recorded and stored in the database in step 108. For example, the additional data recorded can include a sample type which describes the nature of the sample. Exemplary sample types for vegetative type natural products can broadly specify the name of the plant or its genus. Alternatively, or in addition, the sample type can specify certain physical plant structures which comprise the sample, such as leaves, stems, flowers, fruits and/or seeds. In some scenarios, the sample type can specify that the natural product has been minimally processed by means of chopping, grinding or cutting the natural material. In other scenarios, the sample type can specify that the natural product is an extraction or oil extract from a particular plant. In certain scenarios, the sample type can also specify that the natural product sample comprises an edible portion of the plant, a concentrated part of the plant, or a specified liquid suspension or mixture containing the natural material that can be consumed as a drink. From the foregoing, it will be appreciated that one or more data fields can be used to specify the sample type.

Similarly, in step 110 natural product sample data which is recorded and stored in the database can include a sample category. For example, the sample category can include a particular vegetative strain, plant classification, or species so as to identify the nature of the product sample with greater particularity. Any other useful information concerning the product sample can also be recorded in this step, without limitation. For example, the recorded information can include the date that the product sample was received at the testing facility, the person performing the tests, and so on. A visual image or photograph of the product sample can also be captured in this step and stored in the database.

At step 112, the natural product sample is evaluated at the test facility 214 to determine at least one chemical characteristic of each product sample. At a minimum, this means determining by empirical methods the presence or absence of at least one chemical compound. However, the determination of at least one chemical characteristic can also includes determining the relative concentration and/or amounts of certain identified chemical compounds that are present in a particular sample.

The samples of natural products will generally have certain amounts of various chemical elements and compounds. These can include certain elements and/or chemical compounds which are desirable and others which are less desirable or entirely undesirable. For example, one or more of the product samples received at each testing facility can have different amounts of vitamins, minerals, chemical compounds (including medicinal compounds), solvents, pesticides and heavy metals. Solvents, pesticides and heavy metals are obviously undesirable whereas vitamins, minerals and medicinal compounds are desirable. Even among the desirable substances, some may be more preferred as compared to others. Accordingly, the testing facilities are advantageously selected so that they are capable of evaluating one or more chemical characteristics associated with each product. Testing facilities and procedures for determining the presence and amounts of certain substances as described herein are well known and therefore will not be described in detail. The evaluating step will involve determining the amounts and types of certain vitamins, minerals, chemical compounds, solvents, pesticides and heavy metals. The amount of these components found in each product can be of great interest to a consumer who is interested in purchasing natural products, particularly if the natural products are purchased for their specific nutritional content or perceived medicinal value.

Following such evaluation in step 112 the process continues in step 114, where the results of the evaluation are recorded in the database 217. More particularly, for each product sample evaluated, a chemical analysis is performed and the evaluation results are recorded. The date of such testing is also advantageously recorded. The evaluation or testing performed by the test facility will include a determination of at least one chemical characteristic of the product sample. The chemical characteristic evaluated will generally include a determination concerning the presence and/or the concentration of at least one chemical element or compound contained in the natural product. For example, if a particular natural product was being evaluated for its sugar content, the evaluation could include a determination concerning the total concentration and/or relative concentration of various sugar compounds (e.g., glucose, sucrose, and/or fructose). The amount of each chemical element and/or compound can be stated in any suitable scientifically accepted manner used for representing concentration of chemical content in a particular substance. Thus, the amount of a particular element or chemical compound contained in the product can be stated as a percentage of unit weight, by ratio (e.g. parts-per-million) or by any other representative means as commonly used in the art. Although the testing can be limited to determining the presence or concentration of a single element or compound, it can be advantageous to test for a plurality of different chemical elements or compounds which are deemed to be of interest to a purchasing consumer. The natural product can also be tested for the presence of microbial life forms, such as bacterium that are known to cause disease. The foregoing information is then recorded in the database in relation to the product source information. In some embodiments, a test identification number can be assigned to a particular evaluation session in which a product sample is evaluated so as to differentiate the results from all other product sample evaluations. All or some of the information associated with the evaluation can be recorded in the database 217.

Although only one test facility is shown in FIG. 2, it should be understood that natural product testing as described herein can be performed at two or more test facilities which may be located on the same premises, or at different physical locations. When two or more test facilities are used for this purpose, the test results from each facility are advantageously stored in a common database 217. Accordingly, a computer workstation in each facility can advantageously be provided with communication access to a common data storage device 216 for purposes of storing the data described herein.

In step 116 the method continues by facilitating public access to the computer database 217. As shown in FIG. 2, access to the database 217 can be provided by means of a web server 210. Computer web servers are well known in the art and therefore will not be described here in detail. However, it will be appreciated that a web server comprises computer hardware and software which is configured to deliver web content to one or more remotely located client computers. The web content is communicated to remotely located client computers from the web server through a global computer network, such as the Internet. A public computer network 206 as described herein is preferably comprised of a global system of interconnected computer networks that use a standard Internet protocol suite (TCP/IP). Such an arrangement can allow one or more client computers 202₁, 202₂, . . . 202ₙ to communicate with the web server 210. The primary function of the web server 210 is to process and deliver web pages to client computers. Pages served by the web server 210 advantageously comprise HTML documents, which include content such as images, style sheets, scripts, text and so on. Application layer communications between the web server 210 and a plurality of client computers can occur using any suitable method, such as the well-known Hypertext Transfer Protocol (HTTP).

A user agent (such as a web browser software application) which is executing on a client computer 202₁, 202₂, . . . 202ₙ initiates communication with the web browser 210 by making a request for a specific resources available at or through the web server 210. Such a request and the subsequent interactions as described below can similarly be made using a mobile computing device 204₁, 204₂. Exemplary mobile computing devices can include a tablet computers, smart-phones, and/or personal digital assistants (PDA). Still, it should be understood that the invention is not limited in this regard and other types of mobile computing devices can also be used in connection with the inventive arrangements. In the case of interactions using a mobile computing device 204₁, 204₂ a wireless data network 208 can be used in conjunction with the public computer network 206 to facilitate communications with the web server. As a matter of convenience and brevity, the inventive arrangements shall be described in the context of interactions between the web server 210 and one or more of the client computers 202₁, 202₂, . . . 202ₙ. However, it should be appreciated that all such interactions can similarly occur with respect to one or more of the mobile computing devices 204₁, 204₂.

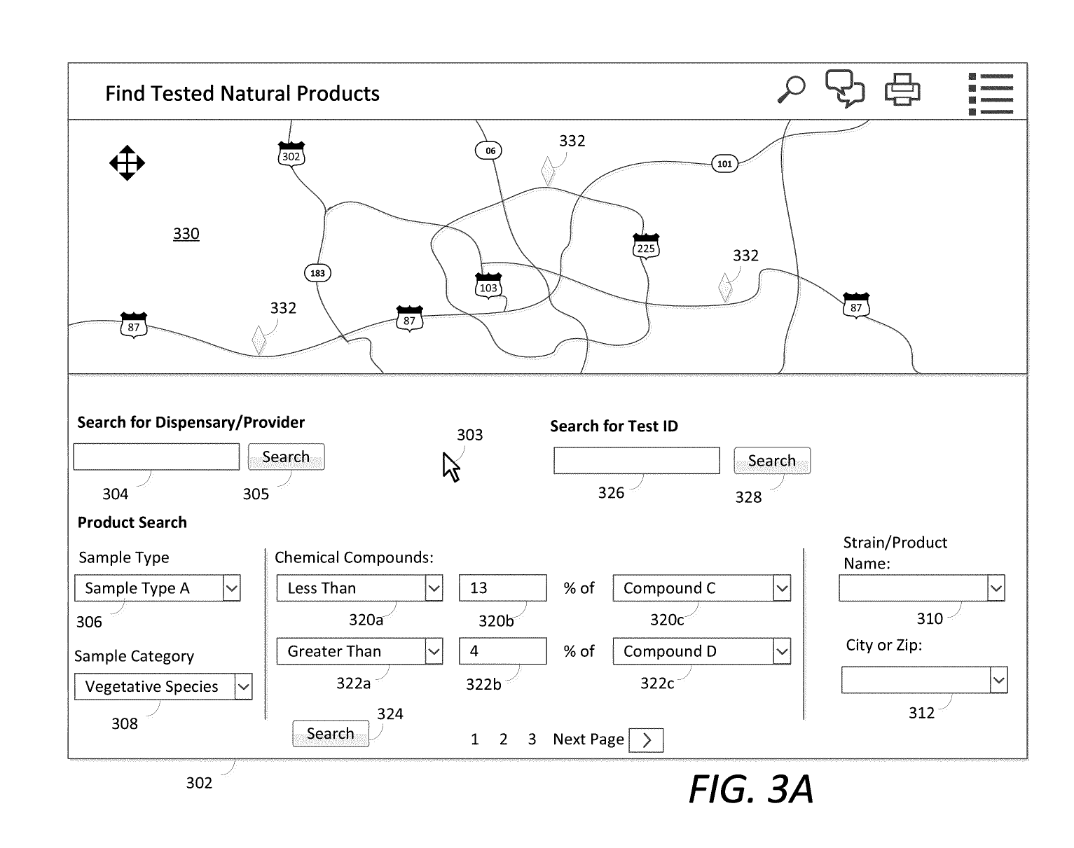

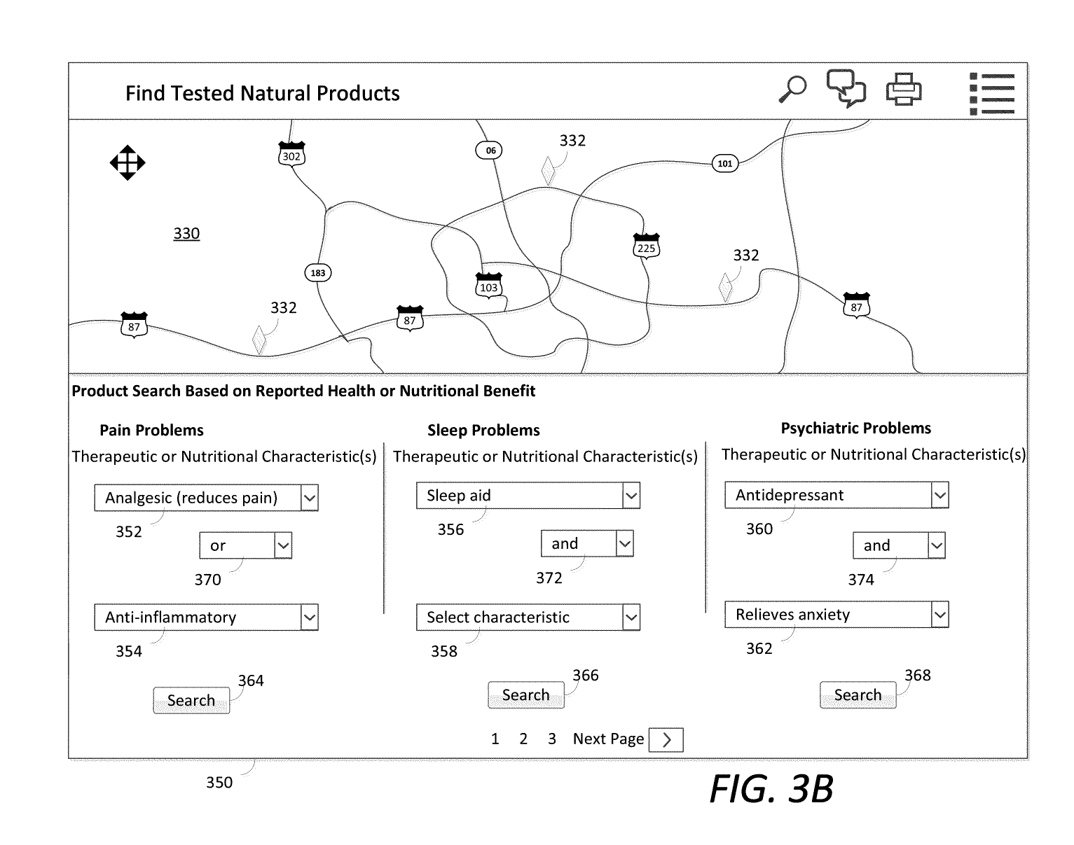

In the present invention, one or more of the client computers and/or mobile computing devices can request an HTML page that facilitates access to data contained in database 217. In response to such a request, the web server 210 can serve one or more HTML web pages which provide a consumer user interface. The consumer user interface advantageously facilitates the generation of user queries which can be used to extract selected data from the database. An exemplary consumer user interface as described herein is shown in FIGS. 3A and 3B.

Referring now to FIG. 3A, an exemplary consumer user interface 302 can include a plurality of data entry fields and/or drop-down lists which can be selected by a consumer to construct a database query. One or more of these fields can define parameters of a query which the database will then use to determine information in the database that should be displayed at a particular client computer 202₁, 202₂, . . . 202ₙ. For example, a query which has been generated using the interface can specify that the user is seeking information concerning a natural product having a predetermined amount of a particular chemical compound.

The process of generating a query can begin by the user selecting a particular natural product sample type. This can be accomplished by selecting a particular natural product sample type from a drop down list in data entry field 306. Once the sample type is selected, the user can utilize data entry field 320c to specify the name of a chemical compound of interest (e.g. Compound C). In data entry field 320b, the user can specify a concentration or relative amount of the particular chemical compound (e.g. 13% in the example shown). In data entry field 320a, the user can specify whether they are seeking data concerning products having more or less than the specified concentration contained in data field 320b. The data entry field 320a in this example shows that the user has specified “Less Than” to limit the data returned by the query to natural product samples having a concentration of less than 13% by weight of Compound C. The precise manner of specifying chemical concentration is not critical and any suitable method can be used to specify the amount of each chemical compound. Also, it should be noted that more complex queries can be generated by using additional data entry fields. For example, data entry fields 322a, 322b, and 322c are similar to data entry fields 320a, 320b, 320c. In the example shown in FIG. 3A, the user has specified that the data returned from the database 217 should be limited to natural products that have a concentration of more than 4% by weight of Compound D. Once the user has assembled his database query using the consumer user interface 302, he can use a cursor 303 to click on a search button 324 to submit the query to the web-server 210.

As an alternative or in addition to the foregoing, parameters included in a user generated query can include other types of data. For example, the query parameters can include a data entry field 308 in which a user of a client computer can specify a natural product sample category; a data entry field 310 in which a user of a client computer can specify a natural product strain or brand name; and a data entry field 312 in which a user of a client computer can specify a geographic area of a natural product source. By inserting search parameters in the referenced data fields, search queries can be formulated that specify groups or sub-groups of data contained in the database. For example, the search parameters can specify that retrieved data is limited to a particular natural product sample category, a particular vegetative product strain or product name, or to a natural product which is available in a particular geographic area (city, zip code).

Other types of data queries can also be generated with user interface 302. For example, the user can enter search parameters to specify that the desired data from database 210 is limited to product samples from a particularly named dispensary/provider. This data can be entered by a user in data entry field 304 in which a user of a client computer can insert the name of a dispensary/provider. Once the name of the dispensary/provider has been entered, the user can submit the search to the web-server by user cursor 303 to click on search button 305. Similarly, the user interface 302 can be used by growers, distributors and other natural product sources to search for test results associated with a particular evaluation of a natural product. This can be accomplished by entering a test ID number or identifier in data entry field 326 and then clicking on the search button 328.

Referring now to FIG. 3B, there is shown a further exemplary consumer user interface 350 which can be provided as an alternative or as an addition to the user interface 302. Like interface 302, the interface 350 includes a plurality of data entry fields and/or drop-down lists 352, 354, 356, 358, 360, and 362 which can be selected by a consumer to construct a database query. One or more of these fields can define parameters of a query which the database will then use to determine information in the database that should be displayed at a particular client computer 202₁, 202₂, . . . 202ₙ. For example, the user interface can facilitate a query which allows the user to seek identification of those natural products having particular chemical compounds which are known or reported to have certain therapeutic effects. Accordingly, the data entry fields and/or drop-down lists 352, 354, 356, 358, 360, and 362 can allow the user to specify certain therapeutic or nutritional characteristics. In the example shown, the user can construct a query seeking information pertain to pain problems, sleep problems and/or psychiatric problems.

In some embodiments, the user interface and database can be configured to require that product sample data retrieved from the database satisfies all specified query parameters specified in the data entry fields by the user at the client computer. Alternatively, the user interface and database can be configured to return data that satisfies at least one specified query parameter. For example, as shown in FIG. 3B, the user can be permitted to select specific therapeutic or nutritional benefits desired (e.g. pain relief) using the drop down lists. The user interface can include additional query inputs (e.g. in the form of drop down lists 370, 372, 374) to define logical operators (e.g., “and”, “or”) that can be used to construct searches for natural products having more than one potential health benefit. Of course other query formulation arrangements are also possible without limitation and the user interface shown is merely one possible example.

After the search query has been formulated as described herein, the user clicks on a search button (e.g. search button 305, 324, 328, 364, 366, 368) to communicate the query from a particular client computer 202₁, 202₂, . . . 202ₙ to the web-server 210 using the public computer network 206. If the query is generated at a mobile device 204₁, 204₂ then the query is communicated to the web server 210 using the wireless data network 208 and the public computer network.

The process continues in step 118 of FIG. 1 with the web server 210 receiving the query from a client computer 202₁, 202₂, . . . 202ₙ or mobile device 204₁, 204₂. The query will include at least one query parameter, such as a minimum (or maximum) concentration of a particular chemical compound. Other exemplary query parameters can include the sample type, the sample category, the strain or product name, and/or the geographic location of a product source. Still other query parameters can include one or more specified therapeutic or nutritional benefits that are desired. Once the query is received at the web server, the query is used in step 120 to retrieve selected data from the database 217. Of course, the invention is not limited in this regard and other query parameters are also possible. The retrieved data will generally include a subset of data records produced as a result of the natural sample product testing. For example, each data record can specify a set of information concerning a particular product sample. The subset of data records returned from the database will be determined by the parameters of the query. For example, if a query parameter specifies a minimum amount of a particular compound, then the data records returned from the database will be only those that have at least the minimum concentration of the particular compound as specified. If the search is further restricted to natural products having a specified source within a particular geographic area (e.g. within a particular zip code), then the data records returned can be limited to those which satisfy the minimum concentration requirement, and further have a specified source within the particular geographic area.

Alternatively, if the query specifies a particular therapeutic or nutritional characteristic (e.g. anti-inflammatory properties) then the data records returned can be limited to those which contain certain compounds in sufficient predetermined concentrations, which are known or reported to have such therapeutic properties or nutritional benefits. The concentration of the chemical compounds associated with such therapeutic or nutritional characteristic will already have been determined during product sample testing. Accordingly, it is a relatively simple matter when searching the database to identify product samples having particular chemical compounds in sufficient predetermined concentrations so as to produce a desired therapeutic or nutritional benefit.

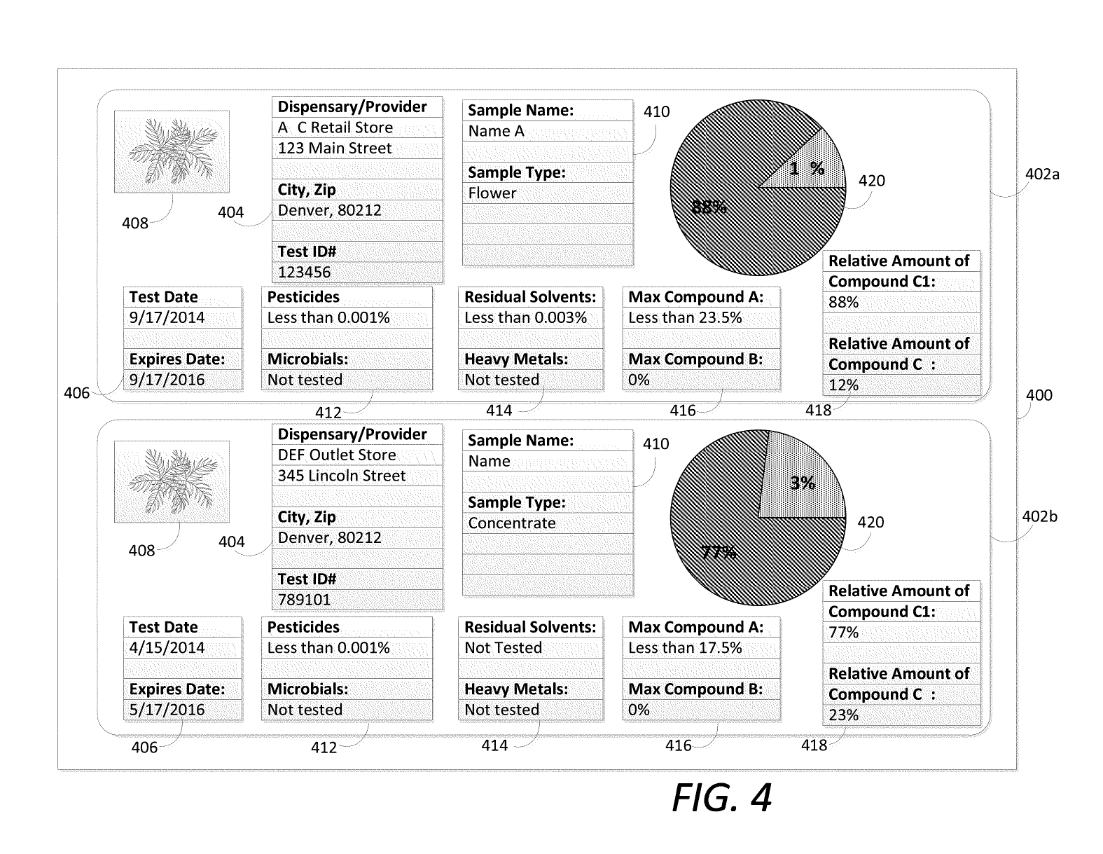

Once the requested data has been retrieved from the database 217 by web server 210, it is formatted and served to the client computer or mobile device which initiated the query. For example, the returned data can be presented as shown in FIG. 4, where it is included as part of An HTML web page 400. According to one aspect of the invention, the data can be presented as a series of data records 402a, 402b, each of which includes pertinent data and test results pertaining to a natural product sample which satisfies the user query parameter(s). For example, in each data record a first data field 404 can include an identification of a source from which a natural product satisfying certain parameters is available to consumers. The source information in data field 404 can include a name and an address of a facility that offers the natural product for sale. A Test ID number can also be included in first data field 404 to provide a means to identify a particular test performed to obtain the information contained in the data record 402a, 402b. General product information can also be included as part of each displayed data record. Such product information can include information deemed to be useful for advertising and marketing of the product. Advantageously, the specified sources of the natural product which satisfy the user query can be displayed in a graphical form, such as road map 330. The various specified sources of the natural products can be displayed in any suitable manner. For example, icons or markers 332 can be used to designate the location of various natural product sources. When the data is presented in this manner, it can facilitate a user determination of which natural product sources are most convenient.

A second data field 406 can include the test date and the expiration date associated with the testing. The expiration date associate with product testing can be important because a natural product sample from one time period may not have consistent properties with respect to a sample from another time period. Hence, it is valuable for consumers to understand when the product was tested, and when the test results are no longer deemed to be valid. An image 406 of the natural product sample which was actually tested can also be included in the data record. The image can be useful to allow consumers to better appreciate the nature and qualities of the natural product. Additional details concerning the natural product sample can be specified in a third data field 410. For example, the sample name (e.g. name of a plant strain and/or species) can be specified. Also the sample type (e.g. the physical part of the plant structure (e.g., flower) or processed form (e.g. concentrate) can be specified.

Each data record 402a, 402b will include information concerning the results of product testing. This information can be presented in tabular form and/or graphic form. Tabular test result fields 412, 414, 416, 418 shown in FIG. 4 include results from testing for pesticides, microbials, residual solvents, heavy metals, the concentration of certain chemical compounds, and the relative amount of certain compounds. If useful for a particular type of natural product, graphical information 420 can also be provided in the data record. Of course, the specific arrangement and type of data included can vary depending on the interests of consumers and the particular type of product content being tested. Accordingly, the invention is not limited to the particular data or arrangements of data shown.

It will be appreciated that the inventive arrangements can be used for any type of natural product where consumers have a need to know the concentration of specific vitamins, minerals and/or chemical compounds. The system is particularly useful for natural products which are intended for human consumption or application to the human body. The amounts and/or concentration chemical components in natural products intended for human consumption or application can be of great interest to consumers who are purchasing such products for specific nutrition and/or health related reasons. The availability and accessibility of reliable testing information obtained regularly based on actual product samples can greatly facilitate user selection and purchase of such products. Accordingly, new product samples can be tested and the results made available to consumers on a regular basis. For example, product testing can be updated weekly, monthly, annually and/or at the completion of each growing season.

From the foregoing it will be understood that the methods described herein can be implemented on a computer system. The computer system can comprise various types of computing systems and devices, including a server computer, a client user computer, a personal computer (PC), a tablet PC, a laptop computer, and a desktop computer. The phrase “computer system” as used herein shall be understood to include any collection of computing devices that individually or jointly execute a set (or multiple sets) of instructions to perform any one or more of the methodologies discussed herein. Any kind of computer system or other apparatus adapted for carrying out the methods described herein is suited. A typical combination of hardware and software can be a general-purpose computer system. The general-purpose computer system can have a computer program that can control the computer system such that it carries out the methods described herein.

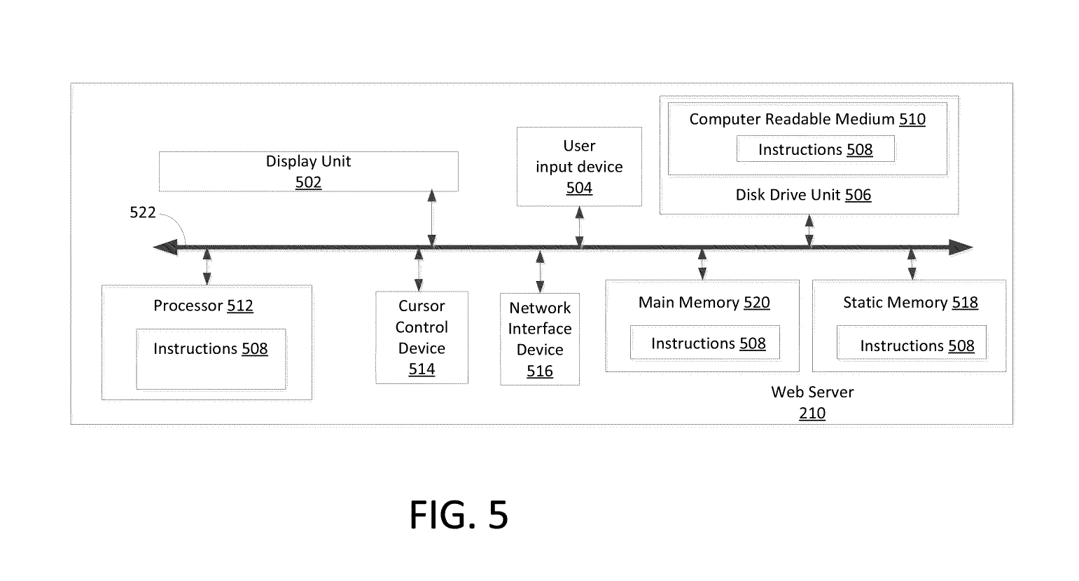

Referring now to FIG. 5, a web server 210 includes a processor 512 (such as a central processing unit (CPU), a disk drive unit 506, a main memory 520 and a static memory 518, which communicate with each other via a bus 522. The web server 210 can further include a display unit 502, such as a video display (e.g., a liquid crystal display or LCD), a flat panel, a solid state display, or a cathode ray tube (CRT)). The web server 210 can include a user input device 504 (e.g., a keyboard), a cursor control device 514 (e.g., a mouse) and a network interface device 516. The network interface device can be arranged to facilitate communications with a computer network, such as public computer network 206.

The disk drive unit 506 includes a computer-readable storage medium 510 on which is stored one or more sets of instructions 508 (e.g., software code) configured to implement one or more of the methodologies, procedures, or functions described herein. The instructions 508 can also reside, completely or at least partially, within the main memory 520, the static memory 518, and/or within the processor 512 during execution thereof by the web server. The main memory 520 and the processor 512 also can constitute machine-readable media.

Those skilled in the art will appreciate that the web server architecture illustrated in FIG. 5 is one possible example of a web server. However, the invention is not limited in this regard and any other suitable computer system architecture can also be used without limitation. For example, the invention can be implemented as a combination of hardware and software in a dedicated computer terminal that is made accessible to the public. An exemplary system could include a publically accessible computer terminal disposed in a kiosk and located in a dispensary, a shopping center and/or shopping mall. Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments may implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described herein are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein. In the various embodiments of the present invention a network interface device 516 connected to a network environment communicates over the network using the instructions 508.

While the computer-readable storage medium 510 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method to facilitate distribution and consumer access to natural products having certain specified characteristics, comprising:
receiving a plurality of product samples comprising natural products at one or more testing facilities, each said product sample being associated with at least one specified source;
evaluating each of said plurality of product samples at said one or more testing facilities to determine at least one chemical characteristic of each said product sample;
storing in a computer database data concerning said specified source of said natural product and corresponding information concerning the at least one chemical characteristic of each said product sample;
providing with a computer server a user interface to facilitate public access to the data contained in the computer database through a publicly accessible computer network, whereby the data can be remotely accessed by potential consumer purchasers of the natural product.

2. The method according to claim 1, wherein the at least one chemical characteristic includes a concentration or amount of a particular chemical compound contained within each of the product samples.

3. The method according to claim 1, wherein the source is a retail location from which said natural product is offered for retail sale.

4. The method according to claim 1, wherein the source is an entity which performs actions selected from the group consisting of growing, distributing, processing and retail sale of said natural product.

5. The method according to claim 1, further comprising receiving at said computer server, from a remote computer terminal connected to said publicly accessible computer network, a query including information specifying at least one parameter for determining which of said data is to be retrieved by the computer server from the database.

6. The method according to claim 5, wherein the at least one parameter specifies a sample type which defines a particular portion of a vegetative product which was evaluated for purposes of determining said at least one chemical characteristic.

7. The method according to claim 5, wherein the at least one parameter specifies a sample type which defines a minimally processed form of the natural product which was evaluated for purposes of determining said at least one chemical characteristic.

8. The method according to claim 5, wherein the at least one parameter specifies a particular plant strain of a vegetative product which was evaluated for purposes of determining said at least one chemical characteristic.

9. The method according to claim 5, wherein the at least one parameter specifies at least one of a minimum and a maximum relative amount of a particular chemical compound contained with the natural product.

10. The method according to claim 5, wherein the at least one parameter specifies a desired concentration of a particular chemical compound contained within the natural product.

11. The method according to claim 5, wherein the at least one parameter specifies a geographic area in which the source is located.

12. The method according to claim 5, wherein the at least one parameter specifies an identity of the source.

13. The method according to claim 5, wherein the at least one parameter specifies a therapeutic or nutritional benefit associated with the natural product.

14. The method according to claim 5, further comprising:
using the computer server to retrieve selected elements of said data from said database responsive to said query; and
using the publicly accessible computer network and the computer server to communicate said selected elements of said data from said computer server to the remote computer terminal.

15. The method according to claim 14, further comprising including in the selected elements information concerning one or more of a concentration of at least one chemical compound determined by said testing, a particular portion of a vegetative type natural product which was evaluated, a processed form of the natural product which was evaluated, a particular plant strain of the vegetative type natural product which was evaluated, a source location and a source identity.

16. The method according to claim 15, further comprising displaying said source location graphically on a map comprising a geographic area.

17. A method to facilitate distribution and consumer access to vegetative products having certain specified characteristics, comprising:
receiving a plurality of product samples comprising vegetative products at one or more testing facilities, each said product sample being associated with at least one specified source;
evaluating each of said plurality of product samples at said one or more testing facilities to determine at least one chemical characteristic of each said product sample, said at least one chemical characteristic including a concentration of a particular chemical compound contained within each of the plurality of product samples;
storing in a computer database data concerning said specified source of said vegetative product and corresponding information concerning the at least one chemical characteristic of each said product sample;
providing with a computer server a user interface to facilitate public access to the data contained in the computer database through a publicly accessible computer network, whereby the data can be remotely accessed by potential consumer purchasers of the vegetative product.
receiving at said computer server, from a remote computer terminal connected to said publicly accessible computer network, a query including information specifying at least one parameter for determining which of said data is to be retrieved by the computer server from the database;
using the computer server to retrieve selected elements of said data from said database responsive to said query; and
using the publicly accessible computer network and the computer server to communicate said selected elements of said data from said computer server to the remote computer terminal, wherein the selected elements comprise one or more of a concentration of at least one chemical compound determined by said testing, an amount of a particular chemical compound, a particular portion of the vegetative product which was evaluated, a processed form of the vegetative product which was evaluated, a particular plant strain of the vegetative product which was evaluated, a source location and a source identity.

18. A system to facilitate distribution and consumer access to natural products having certain specified characteristics, comprising:
a computer database on which is stored a plurality of data records comprising test result information concerning a plurality of product samples comprising natural products which have been tested at one or more testing facilities, each said product sample being associated with at least one specified source, and said test result information including at least one chemical characteristic determined for each of said product sample;
a computer server which accesses the data contained in the computer database and is communicatively coupled to a public computer network, said computer server responsive to a request from at least one remote client computer to provide a computer user interface which facilitates public access to the plurality of data records contained in the computer database;
said computer server responsive to at least one query received from said remote client computer to selectively retrieve one or more of the data records from the computer database, and to cause information contained in one or more of said data records to be displayed at the remote computer, said information that is displayed indicating at least one source of the natural product which satisfies at least one parameter specified by the query.

19. The method according to claim 18, wherein the at least one chemical characteristic comprises a concentration or amount of a particular chemical compound contained within each of the product samples.

20. The system according to claim 18, wherein the at least one parameter specified by the query comprises at least one of a maximum or minimum relative amount of a particular chemical compound contained with the natural product.

21. The system according to claim 18, wherein the at least one parameter specified by the query specifies a desired concentration of a particular chemical compound contained within the natural product.

22. The system according to claim 18, wherein the at least one parameter specifies a geographic area in which the source is located.

23. The system according to claim 18, wherein the at least one parameter specified by the query includes a user desired therapeutic or nutritional benefit of a natural product.
